(19) United States
(12) Patent Application Publication
(10) Pub. No.: US 2009/0301326 A1
(43) Pub. Date: Dec. 10, 2009

(54) COATED PRINT ROLL AND METHOD THEREFOR

(76) Inventors: George A. Barr, Denver, NC (US); Franz W. Kellar, Gastonia, NC (US); Donald G. Faulkner, Charlotte, NC (US); Walter Siegenthaler, Cornelius, NC (US)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/159,700

(22) PCT Filed: Dec. 30, 2006
(86) PCT No.: PCT/US06/62772

§ 371 Date: Aug. 19, 2009

Related U.S. Application Data
(60) Provisional application No. 60/766,080, filed on Dec. 30, 2005.
(60) Provisional application No. 60/844,819, filed on Sep. 15, 2006.

(51) Int. Cl. B41F 11/00

(52) U.S. Cl. 101/328

(57) ABSTRACT

A print roll has opposed ends and a generally cylindrical print surface, and a carbon-based thin film having an amorphous microstructure disposed on the print surface. The thin film may have multiple layers and may be applied by plasma assisted chemical vapor deposition.

### BACKGROUND OF THE INVENTION

This invention relates generally to wear coatings and surface treatments and their manufacture, and more particularly to a method for applying wear treatment to printing rolls.

Printing processes are often carried out using cylindrical “print rolls”. These are metallic rolls with ink pockets formed therein, and are used for processes such as transferring an ink image directly to a substrate, or transferring fluid media (e.g., ink, varnish) from one step in a printing process to another (e.g. as a “metering roll”) via transfer pockets.

Print rolls and metering rolls are subject to mechanical wear, foreign substances, moisture, and chemical attack. All of these hazards reduce the useful life of the print roll.

### BRIEF SUMMARY OF THE INVENTION

Accordingly, it is an object of the invention to provide a highly durable print roll.

It is another object to provide a method for method for coating a print roll.

It is yet another object of the invention to provide a method for forming ink pockets in a coated print roll.

These and other objects are addressed by the present invention, which according to one aspect provides a print roll having opposed ends and a generally cylindrical print surface, and a carbon-based thin film having an amorphous microstructure disposed on the print surface.

According to another aspect of the invention, a method of making a print roll having opposed ends and a generally cylindrical print surface includes applying a carbon-based thin film having an amorphous microstructure to the print surface.

### BRIEF DESCRIPTION OF THE DRAWINGS

The invention may be best understood by reference to the following description taken in conjunction with the accompanying drawing figures in which:

FIG. 1 is a schematic perspective view of a print roll coated in accordance with the present invention;

FIG. 2 is an end view of the print roll of FIG. 1;

FIG. 3 is an enlarged cross-sectional view of a portion of the print roll of FIG. 2;

FIG. 4 is a schematic cross-sectional view of a coating apparatus for use with the present invention.

FIG. 5 is an enlarged cross-sectional view of a portion of an alternative print roll with a thin film applied thereto;

FIG. 6 is a view of the print roll of FIG. 5 after etching thereof; and

FIG. 7 is a view of the print roll of FIG. 6 with an additional thin film applied thereto.

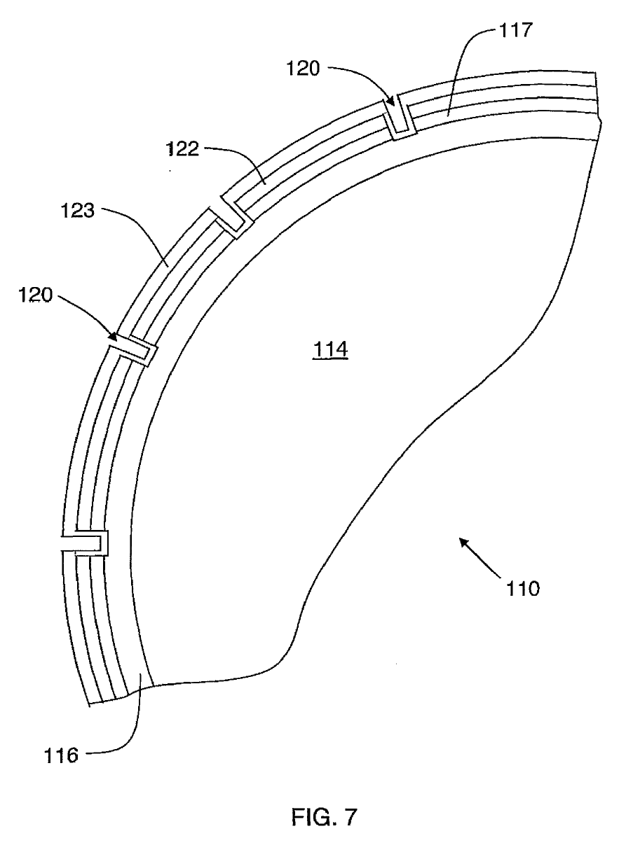

### DETAILED DESCRIPTION OF THE INVENTION

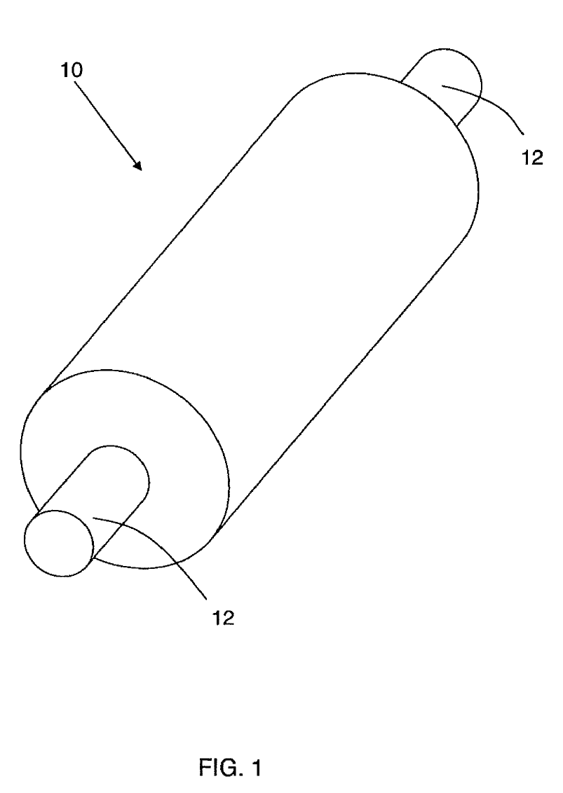

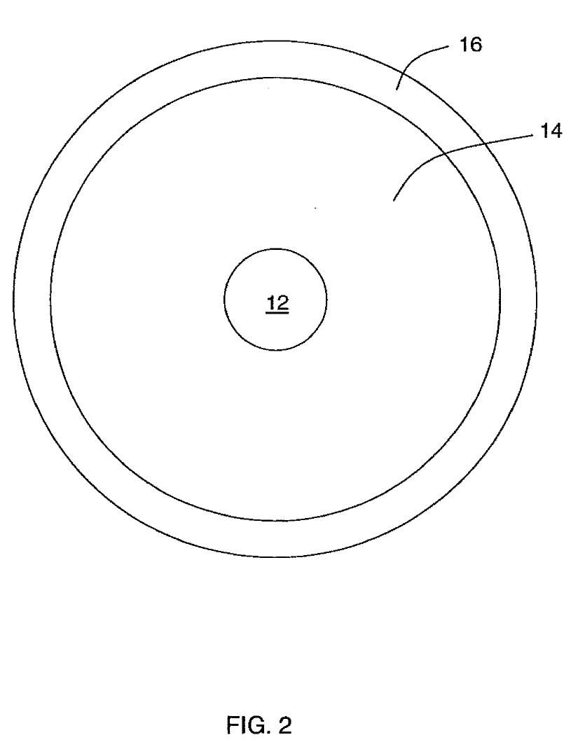

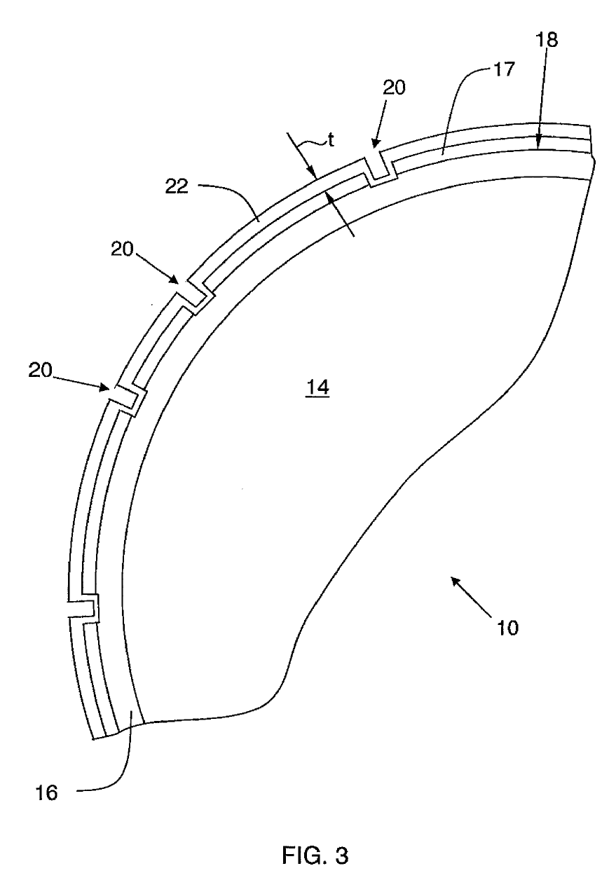

Referring to the drawings wherein identical reference numerals denote the same elements throughout the various views, FIGS. 1-3 depict an exemplary print roll 10 constructed in accordance with the present invention. As used herein, the term “print roll” is used to refer generally to any roll-like component of printing machinery used to hold, transfer, meter, or apply ink, varnish, or other fluids. The print roll 10 is generally cylindrical and has opposed ends with mounting shafts or other fixation means 12. In the illustrated example, the print roll 10 has a core 14 with a relatively thin facing layer 16 disposed thereon. The facing layer 16 may be metallic, for example a steel or copper alloy, and may be applied through a plating process. Other materials such as ceramics, plastics, polymers, elastomers, or resins may also be used for the facing layer 16. The print roll 10 could also be of solid construction, for example steel, aluminum, or copper alloy, without the facing layer 16. In one known type of construction, referred to as “Anilox”, the core 14 is a material such as steel or aluminum, and the facing layer 16 is a ceramic or ceramic-metallic material.

The print roll has a print surface 18 which has a plurality of ink pockets 20 (or cells) formed therein in a known manner, for example using mechanical engraving, laser engraving, or chemical etching. In operation, these ink pockets 20 receive ink from a supply sump or roll and then transfer the ink to a downstream printing roll, printing plate or directly to a substrate to be printed. Therefore, the ink pockets 20 could be in the form of a selected image or they could simply be reservoirs of an arbitrary shape.

The entire print surface 18 of the print roll 10 and the interior of each ink pocket 20 has a coating 22, hereinafter referred to as a “thin film”, of a carbon-based coating material deposited thereon. This material has an amorphous microstructure and exhibits a flexural capability of approximately 35% or better. This enables the thin film 22 to endure significant vibration without cracking or detaching from the substrate. Such thin films may be obtained from Performance Roll Processing LLC, Gastonia, N.C., 28054. In the illustrated example, the thin film 22 has a thickness “t” from about 2 μm (0.08 mil) to about 6 μm (0.24 mil), and more specifically from about 2 μm (0.08 mil) to about 3 μm (0.12 mil).

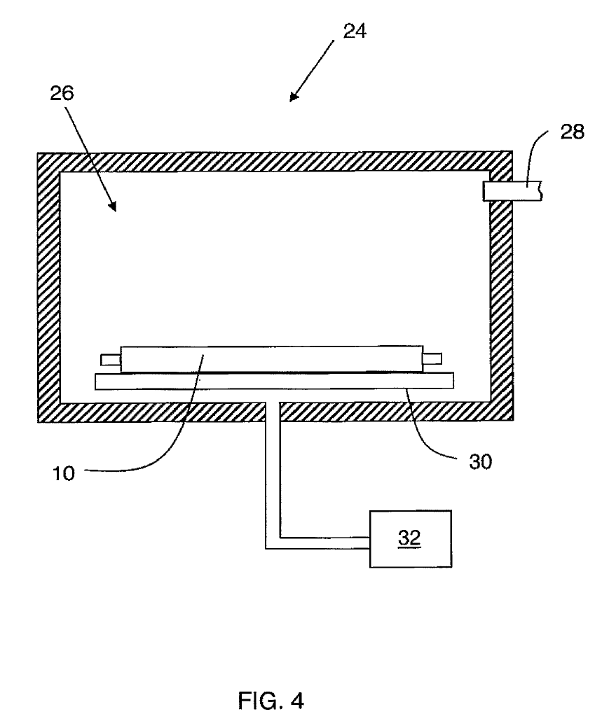

FIG. 4 illustrates an exemplary coating apparatus 24 for applying the thin film 22 to the print roll 10. The coating apparatus 24 is a plasma assisted chemical vapor deposition (PACVD) apparatus of a known type. It includes a processing chamber 26 which receives the workpiece, a hydrocarbon gas source 28, an RF field generator 30 of a known type, and a vacuum pump 32.

Prior to coating, the print surface 18 of the print roll 10 may be subjected to cryogenic treatment in a known manner. This may produce a desirable substrate structure for the thin film 22.

The coating process proceeds as follows. The uncoated print roll 10 is placed in the processing chamber 26.

The print roll 10 is then cleaned in a known manner (for example using plasma cleaning) to eliminate any foreign material or contaminants from the surface thereof. The shafts 12 may be masked to prevent coating buildup thereon. The thin film 22 is then deposited all over the exterior of the print roll 10 and into the ink pockets 20 using a deposition process such as plasma assisted chemical vapor deposition (PACVD) process. The RF field which generates the plasma is specially manipulated so that the thin film material is deposited “around the corner” between the surface of the print roll 10 and the ink pockets 20. That is, the coating process does not require a direct line-of-sight to the pockets 20 to achieve a satisfactory thin film application therein.

Once the coating cycle is complete, the print roll 10 is then removed from the processing chamber 26.

A print roll 10 coated as described above is expected to be significantly more wear resistant than an uncoated print roll 10. The thin film 22 retains substantially sharp, square corners at the intersections of the ink pockets 12 with the print surface 18. The thin film 22 also increases the surface tension angle of the “coated” ink pocket 20, thus forming a smaller or sharper ink droplet (in the ink pocket 20) resulting in sharper printing. In other words, the ink droplet will act as a smaller droplet in the same size pocket. This results in sharper printing, and the option of higher resolution dot placement (i.e. higher pocket density).

The thin film 22 is highly flexible to allow component flexibility while maintaining mechanical adhesion to the base material. In other words, roll deflection will not weaken or crack the thin film 22. The thin film 22 creates a complete sealing boundary layer against chemicals, moisture, other materials, and fluids. It also has a high mechanical wear resistance, e.g. it reduces wear from abrasive inks and roll knives, doctor blades or other wiping elements.

The thin film 22 reduces component surface friction (especially between a doctor blade used in printing machinery and the print surface 18), which creates less buildup and adhesion of other materials to features of the component. It also facilitates release of inks from engraved or etched ink pockets 20.

Furthermore, this process may not require chrome plating of the surface 18, as used in the prior art, and therefore provides the environmental and safety benefits of elimination of chrome plating. This may be particularly desirable for medium to high volume printing requirements. If desired, a chrome layer 17 may be applied to the print roll 10 under the thin film 22.

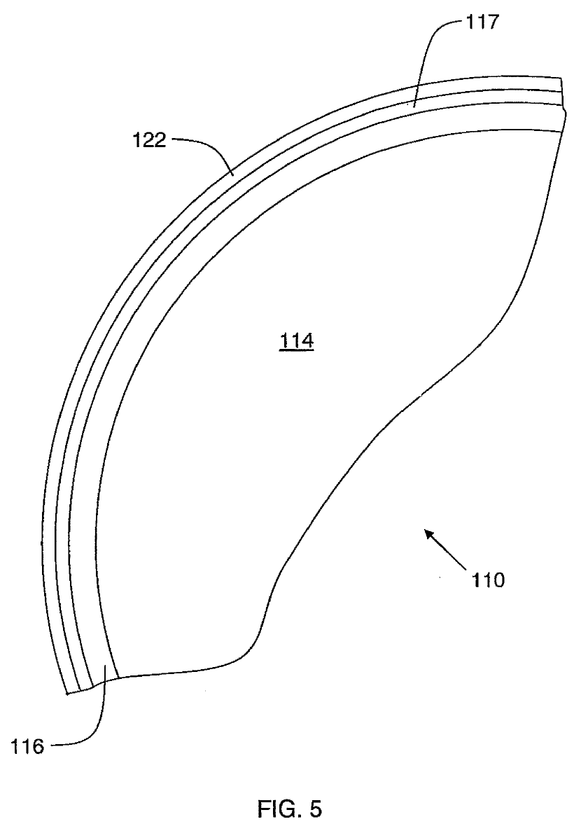

The thin film may also be applied in a two-step process. This process is described with reference to an exemplary print roll 110 similar to the print roll 10. As shown in FIG. 5, a print roll 110 with a core 114 and optionally a layer 116 is provided. As noted above, particularly useful print roll constructions include a steel alloy core 114, a copper alloy layer 116 with or without a chrome layer 117, or a steel, aluminum, or other rigid core 114 with a ceramic layer 116. In a first step, the print roll 110 is coated with a thin film 122 of the carbon-based material as described above.

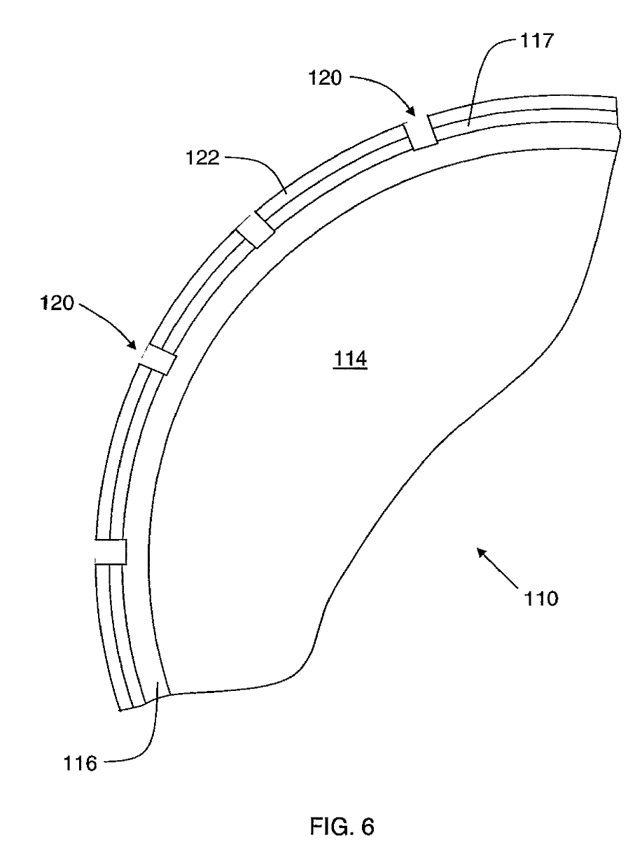

The print roll 110 is then etched, for example using a laser of a known type, to create ink pockets (or cells) 120, as shown in FIG. 6. The thin film 122 receives laser power very well and allows a clean laser border (cell perimeter), thus producing a more/better defined pocket edge, as compared to an uncoated print roll 110. This would allow a higher print resolution or better print quality (i.e. better ink spot definition) than for prior art processes. The thin film 122 maintains surface integrity between engraved or etched areas after engraving process (there is very limited mechanical degradation of thin film between engraved pockets 120).

This coating method would allow essentially “instant printing” after the laser etching is completed. In this instance, the thin film 122 serves two purposes. It provides an extremely wear resistant yet resilient surface, while also providing a surface that readily optically accepts the etching laser beam for etching individual ink pockets 120, and the coating 122 facilitates a clean, distinct etching perimeter around the edge of the ink pocket 122. In comparison, prior art processes often require the print roll 110 to be sent to a plater for chrome plating after etching, with its attendant human and environmental hazards, prior to beginning the printing process.

After etching, the print roll 110 is optionally coated again in a process step to add thin film 123 to the ink pockets 120, thus providing a completely covered roll, as shown in FIG. 6. The ink pockets 120 could also be individually coated without producing a double layer of thin film by appropriate masking of the print roll 110 during the coating process. Coating after the laser engraving process would provide a reinforcing and wear resistant layer to the engraved metering or print roll surface, lower the surface tension angle of the resulting surface, and additionally reinforce the smaller microfractures caused by the laser engraving process by being fully conformal to the substrate of the cell and cell rim. It is also anticipated that a higher cell density for a given area could be achieve by the application and use of smaller cells that could exploit the composite benefit of lower surface tension characteristic of the cell and cell rim and the interaction of the inks formulated specifically for this type of cell. This could be especially beneficial when using water based inks.

The thin film as described above will encase the print roll in a nonreactive, inert case for all unmasked areas. The flexural nature of the thin film will allow it to remain attached to the print roll 10 even during static or cyclic deflection of the print roll (which naturally occurs during use because the print roll is a simply supported beam element).

The thin film 22 will facilitate more efficient, effective, and complete cleaning of print or metering rolls due to the inert (chemically nonreactive) and conformal nature (smooth surface molecular structure). There will also for the same reason be less buildup of print fluid due to the tendency of ink to readily come back off the print roll surface (increased surface tension angle, less fluid adhesion and cohesion area). It is anticipated that low power laser cleaning methods will be more productive than with an uncoated print roll.

It is further anticipated that specialized doping agents could be introduced in to the thin film composition to alter the surface tension, alter the surface lubricity or the wetting or nonwetting response of characteristics of certain chemistries or to have other structural or surface interactive benefits.

Additionally, the coated ink pockets would be more resistant to the compaction of ink colorant particles in the cell depression due to the higher hardness and the thin film's flexural nature to resist the localized impact or repeated localized compaction pressure stress associated with ink and pigment particle residue.

It is also possible to use the laser in combination with an aqueous or solvent based cleaning solution(s) having a reduced surface tension and emulsifying agents to facilitate “micro-cavitation” (i.e. low pressure boiling and agitation of the cleaning solution thus enhancing ink and particle cleaning from the ink pockets 20) to aid in the cleaning of the roll surface 18. The cleaning solution could be supplied at or surrounding the point of laser concentration and could be coupled with a suction evacuation to remove the spent solution and debris. Furthermore, the resilience of the thin film may make it possible to better clean Anilox or other ceramic or ceramic-metallic composite rolls with less ceramic substrate cracking and micro degradation using ultrasonic cleaning.

It will also be possible to clean the coated roll with a waterjet stream (pulsed or steady-state) by passing (via a radial motion head or static single or multiple orifice nozzle) a stream over the surface of the print roll. The resilience and adhesion quality of the thin film will allow reception of the waterjet stream that will remove ink and other extraneous print fluids on the print roll surface and in the ink pockets without damaging or removing the thin film. The chrome or otherwise treated print roll substrate will remain untouched and undamaged. With prior art hard surface treatments, such as aluminum oxide, too high of a pressure will cause microcracking and depletion of the surface thus damaging the critical roll surface due to the hard and brittle nature of these materials.

The foregoing has described a coated print roll, apparatus for applying a coating to such a print roll, and a method for applying such a coating. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A print roll having opposed ends and a generally cylindrical print surface, and a carbon-based thin film having an amorphous microstructure disposed on the print surface.

2. The print roll of claim 1 wherein the thin film has a flexural capability of at least about 35%.

3. The print roll of claim 1 wherein the thin film has a thickness of about 2 μm to about 6 μm.

4. The print roll of claim 1 wherein the thin film has a thickness of about 2 μm to about 3 μm.

5. The print roll of claim 1 further comprising a generally cylindrical core covered by a facing layer which defines the print surface.

6. The print roll of claim 5 wherein the core is selected from the group consisting of steel, aluminum, and copper, and alloys thereof.

7. The print roll of claim 5 wherein the facing layer is selected from the group consisting of steel, copper, ceramics, plastics, polymers, elastomers, and resins, and combinations thereof.

8. The print roll of claim 5 wherein:
(a) the core is selected from the group consisting of steel, aluminum, or alloys thereof; and
(b) the facing layer is selected from the group consisting of ceramic and ceramic-metallic materials, and mixtures thereof;

9. The print roll of claim 1 further comprising a layer of chrome disposed on the print surface underneath the thin film.

10. The print roll of claim 1 further including a plurality of recessed ink pockets formed in the print surface, wherein the thin film covers substantially all of the print surface and the ink pockets.

11. The print roll of claim 1 further including a plurality of recessed ink pockets formed in the print surface, wherein the thin film covers substantially all of the print surface and substantially does not cover the ink pockets.

12. The print roll of claim 11 further including an additional thin film covering substantially all of the print surface and the ink pockets.

13. A method of making a print roll having opposed ends and a generally cylindrical print surface, the method comprising applying a carbon-based thin film having an amorphous microstructure to the print surface.

14. The method of claim 13 in which the thin film is applied using a plasma-assisted chemical vapor deposition process.

15. The method of claim 13 further comprising forming a plurality of recessed ink pockets in the print surface prior to applying the thin film to the print surface, such that the think film covers the print surface and substantially all of the ink pockets.

16. The method of claim 13 further comprising forming a plurality of recessed ink pockets in the print surface subsequent to applying the thin film to the print surface.

17. The method of claim 16 further comprising apply an additional thin film to the print surface and to the ink pockets after forming the ink pockets.

18. The method of claim 13 wherein the applied thin film has a flexural capability of at least about 35%.

19. The method of claim 13 wherein the thin film is applied to a thickness of about 2 μm to about 6 μm.

20. The method of claim 1 wherein the thin film is applied to a thickness of about 2 μm to about 3 μm.
